(19) United States
(12) Patent Application Publication
(10) Pub. No.: US 2014/0185080 A1
(43) Pub. Date: Jul. 3, 2014

(54) POWER SUPPLY MANAGEMENT SYSTEM

(71) Applicant: KYOCERA Document Solutions Inc., Osaka (JP)

(72) Inventor: Tomoaki MORITA, Osaka (JP)

(73) Assignee: KYOCERA Document Solutions Inc., Osaka (JP)

(21) Appl. No.: 14/136,186

(22) Filed: Dec. 20, 2013

(30) Foreign Application Priority Data
Dec. 28, 2012 (JP) 2012-287071

(51) Int. Cl. G06F 3/12

(52) U.S. Cl. CPC G06F 3/1221; G06F 3/1229
USPC 358/1.14

(57) ABSTRACT

A power supply management system includes an off-operation register configured to hold a situation of reception of an off-operation of a power supply and a power control unit configured to turn off the power supply upon receiving a power-off request from a server via a network. The server includes a server control unit that serves as an off-operation situation grasping unit for grasping, via the network, the situation of reception of the off-operation held in the off-operation register and serves as a power-off request transmitting unit for transmitting the power-off request via the network to the entire image forming devices belonging to a group in which the entire image forming devices have received the off-operation.

### CROSS-REFERENCE TO RELATED APPLICATION(S)

This application is based upon and claims the benefit of priority from Japanese Patent Application(s) No. 2012-287071 filed on Dec. 28, 2012, the entire contents of which are incorporated herein by reference.

### BACKGROUND

The technology of the present disclosure relates to a power supply management system that manages power supplies of a plurality of image forming devices connected to a network.

In recent years, a plurality of image forming devices such as copiers, multifunction peripherals (MFPs) and the like is connected by a network. If a plurality of image forming devices is connected by a network, it becomes possible to link the image forming devices and to perform a large amount of processing within a short period of time. By linking a plurality of image forming devices, document data stored in a document box of an image forming device can be referred to and printed by another image forming device.

However, if a power supply of an image forming device including a communication unit connected to a network is turned off in order to reduce power consumption, the image forming device cannot be recognized by other image forming devices via a network. For that reason, if there is a possibility that at least one of linked image forming devices will be used, the power supplies of the remaining image forming devices should not be turned off without permission. Therefore, a user needs to turn off the power supplies of the linked image forming devices one by one at a stage when all the linked image forming devices become out of use. However, the turn-off operation becomes cumbersome and onerous if the installation places of the image forming devices are far away from one another or if the image forming devices are disposed on different floors. In addition, since a plurality of image forming devices needs to be managed at the same time, a possibility of forgetting to turn off the power supplies of some of the image forming devices becomes higher.

### SUMMARY

A power supply management system according to the technology of the present disclosure includes a plurality of image forming devices connected to a network and a power supply management device configured to manage power supplies of the image forming devices. Each of the image forming devices includes a power switch configured to receive an off-operation of each of the power supplies performed by a user, an off-operation holding unit for holding a situation of reception of the off-operation received by the power switch, and a power control unit configured to turn off the power supplies upon receiving a power-off request from the power supply management device via the network. The power supply management device includes a device information storage unit for storing group information that groups the image forming devices, an off-operation situation grasping unit for grasping, via the network, the situation of reception of the off-operation held in the off-operation holding unit of each of the image forming devices, and a power-off request transmitting unit for, based on the situation of reception of the off-operation grasped by the off-operation situation grasping unit and the group information, transmitting the power-off request via the network to the entire image forming devices belonging to a group in which the entire image forming devices have received the off-operation.

### BRIEF DESCRIPTION OF THE DRAWINGS

FIG. 1 is a system configuration diagram showing one embodiment of a power supply management system according to the technology of the present disclosure.

FIG. 2 is a block diagram showing a schematic configuration of one of the image forming devices shown in FIG. 1.

FIGS. 3A and 3B are views showing one example of off-time information and one example of group information stored in a device information storage unit of a server shown in FIG. 1.

FIG. 4 is a flowchart for explaining a power supply management operation of the server shown in FIG. 1.

### DETAILED DESCRIPTION

An embodiment will now be described in detail with reference to the drawings.

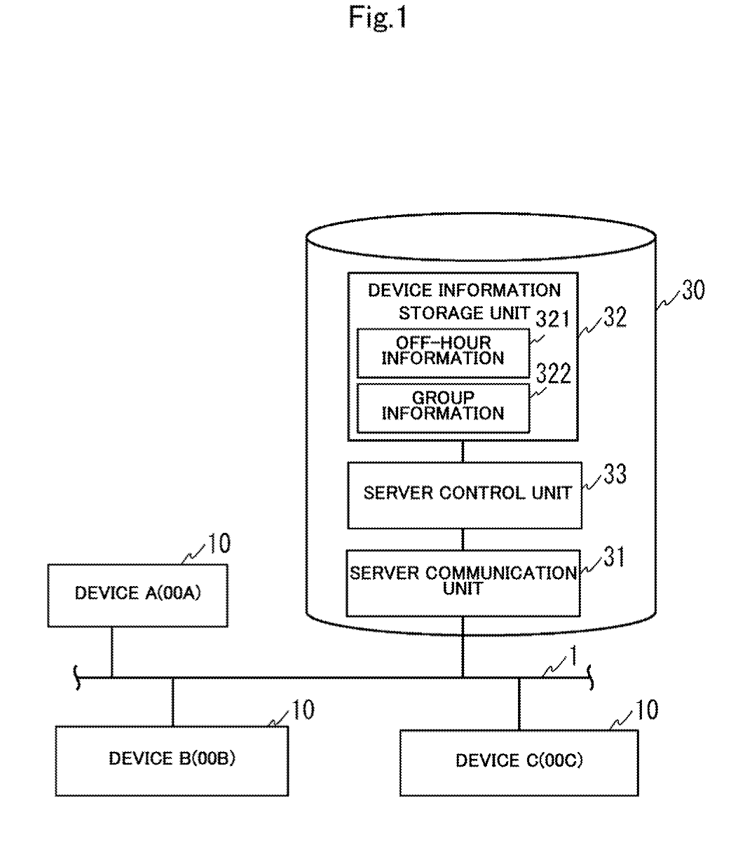

Referring to FIG. 1, a power supply management system according to the present embodiment includes a plurality of image forming devices 10 connected to a network 1 such as a LAN or the like and a server 30 connected to the network 1. In the present embodiment, three image forming devices 10 including a device A having a device code “00A”, a device B having a device code “00B” and a device C having a device code “00C” are connected to the network 1.

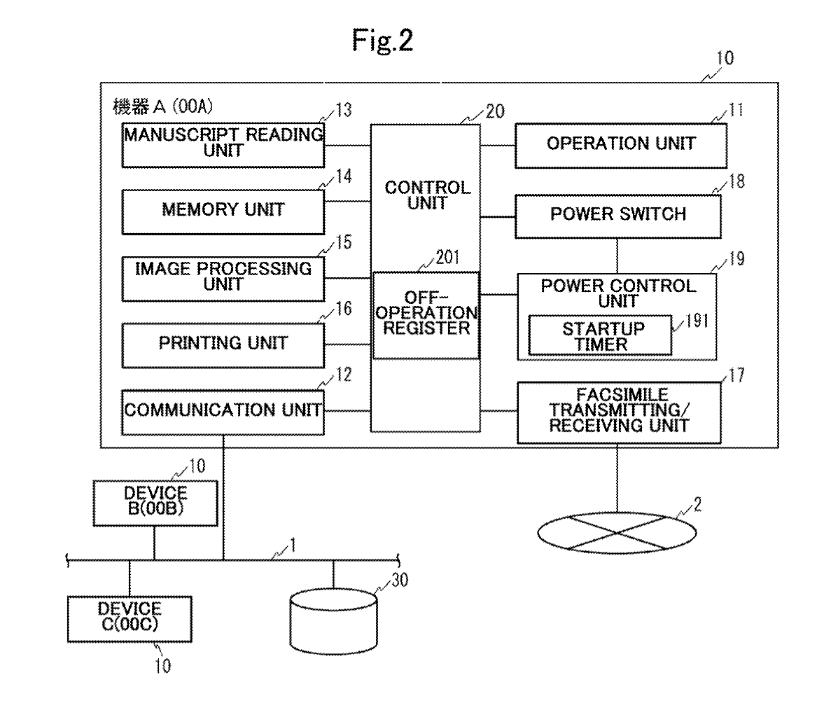

The image forming devices 10 are multifunction peripherals (MFPs) that have a copier function, a scanner function, a facsimile function, a network communication function and the like. Referring to FIG. 2, each of the image forming devices 10 includes an operation unit 11, a communication unit 12, a manuscript reading unit 13, a memory unit 14, an image processing unit 15, a printing unit 16, a facsimile transmitting/receiving unit 17, a power switch 18, a power control unit 19 and a control unit 20.

The operation unit 11 is a user interface. The operation unit 11 includes: a touch panel serving as a display means and an input means, the touch panel formed by arranging transparent pressure-sensitive sensors on a surface of a liquid crystal display panel; and different kinds of operation keys such as numerical keys for inputting a numerical value such as a number of printing papers or the like, a reset key for inputting an instruction that initializes pre-set information, a stop key for stopping a copying operation or erasing an inputted numerical value, an interrupt key for instructing an interrupt copying operation, a start key for inputting an output instruction that causes a printing operation to be started, and the like.

The communication unit 12 has a function of transmitting and receiving different kinds of data to and from the server 30 or other image forming devices 10 via the network 1 such as a LAN or the like.

The manuscript reading unit 13 is a scanner that reads a manuscript image by irradiating light toward a manuscript fed by a manuscript feeding unit not shown or a manuscript placed on a platen glass by a user and receiving the light reflected from the manuscript.

The memory unit 14 is a memory means, such as a semiconductor memory or a hard disk drive (HDD), which stores document data read by the manuscript reading unit 13 or document data received by the communication unit 12. In the present embodiment, the document data is document information composed of image data, text data, diagram data or the combination thereof.

The image processing unit 15 performs predetermined image processing with respect to the document data. The image processing unit 15 performs, e.g., enlargement/reduction processing and image improvement processing such as concentration adjustment or gradation adjustment.

The printing unit 16 prints the document data stored in the memory unit 14 as a document image. The printing unit 16 performs, e.g., image formation by forming a latent image on a surface of a photosensitive drum based on the document data read from the memory unit 14 and converting the latent image to a tonner image using a toner. The printing unit 16 transfers the tonner image from the photosensitive drum to a recording paper, fixes the tonner image to the recording paper and discharges the recording paper.

The facsimile transmitting/receiving unit 17 includes a modem. The facsimile transmitting/receiving unit 17 has a facsimile transmitting function of generating a facsimile signal from image data read by the manuscript reading unit 13 or image data stored in the memory unit 14 and transmitting the generated facsimile signal via a public network 2, and a facsimile receiving function of receiving a facsimile signal via the public network 2.

The power switch 18 is a power supply operating unit for receiving a user's on-operation which instructs power-on of the image forming devices 10 and a user's off-operation which instructs power-off of the image forming devices 10. Alternatively, the off-operation may be received by the operation unit 11.

The power control unit 19 controls on/off operations of power supplies of the image forming devices 10. If an on-operation is received by the power switch 18 in a power-off state, the power control unit 19 turns on the power supplies of the image forming devices 10. On the other hand, when an off-operation is received by the power switch 18 in a power-on state, the power control unit 19 does not turn off the power supplies of the image forming devices 10. If power-off is instructed by the control unit 20, the power control unit 19 turns off the power supplies of the image forming devices 10. In the present embodiment, even though the off-operation is received by the power switch 18, the power supplies of the image forming devices 10 are not immediately turned off. Thus, a message notifying a user of the reception of the off-operation may be displayed on the operation unit 11, or the image forming devices 10 may be shifted to a sleep mode with the communication unit 12 kept activated.

The power control unit 19 is provided with a startup timer 191 having a clocking function. An on-hour at which the power supplies of the image forming devices 10 are turned on is set in the startup timer 191. The on-hour can be set on a yearly basis, a monthly basis, a weekly basis or a daily basis. For example, AM 8:30 on Monday to Friday can be set as the on-hour on a weekly basis. If the arrival at the predetermined on-hour is detected by the startup timer 191, the power control unit 19 turns on the power supplies of the image forming devices 10.

The control unit 20 is connected to the operation unit 11, the communication unit 12, the manuscript reading unit 13, the memory unit 14, the image processing unit 15, the printing unit 16, the facsimile transmitting/receiving unit 17, the power switch 18 and the power control unit 19. The control unit 20 controls the overall operations of the image forming devices 10 according to the predetermined instruction information inputted from the operation unit 11. The control unit 20 is an information processing unit, such as a microcomputer or the like, which includes a ROM (Read Only Memory), a RAM (Random Access Memory) and the like. A control program for controlling the operations of the image forming devices 10 is stored in the ROM. By reading out the control program stored in the ROM and deploying the control program in the RAM, the control unit 20 controls all the devices according to the predetermined instruction information inputted from the operation unit 11.

The control unit 20 includes an off-operation register 201 that holds a situation of reception of the off-operation received by the power switch 18. The off-operation register 201 is set if the off-operation is received by the power switch 18. The off-operation register 201 is reset if the operation of the operation unit 11 or the on-operation of the power switch 18 is received or if the power supplies of the image forming devices 10 are turned off. Upon receiving an off-operation confirmation request from the server 30, the control unit 20 transmits to the server 30 an off-operation response that notifies whether the off-operation register 201 is set or not. Upon receiving a power-off request from the server 30, the control unit 20 instructs the power control unit 19 to turn off the power supplies.

The server 30 manages the power supplies of the image forming devices 10 connected to the network 1. Referring to FIG. 1, the server 30 includes a server communication unit 31, a device information storage unit 32 and a server control unit 33.

The server communication unit 31 transmits and recieves different kinds of data to and from the image forming devices 10 connected to the network 1.

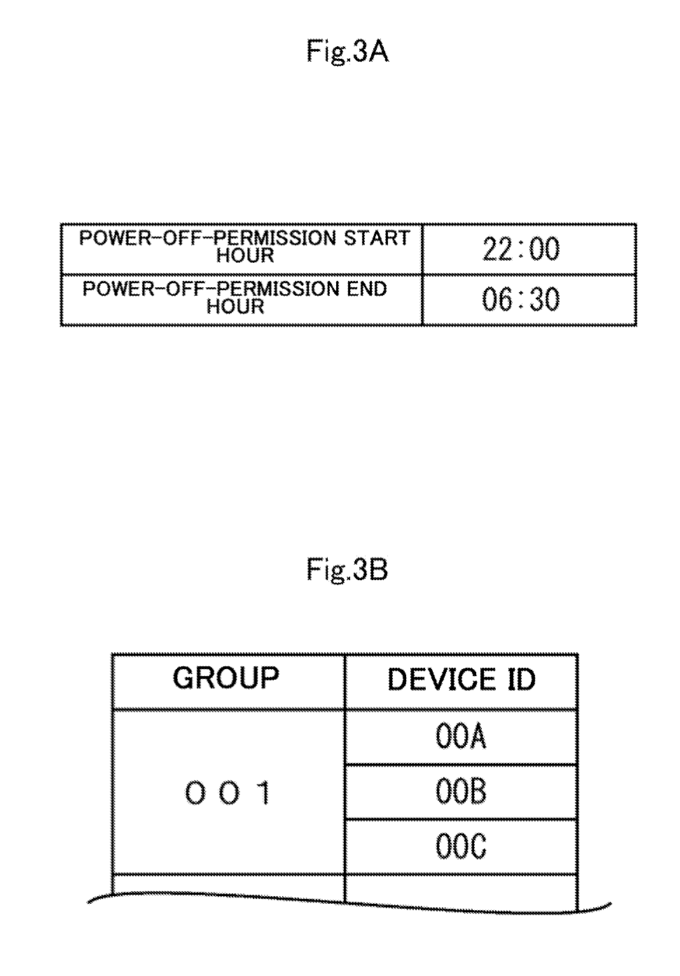

The device information storage unit 32 is a memory means such as a semiconductor memory or a HDD. The device information storage unit 32 stores off-hour information 321 that sets a power-off-permission time zone during which the power supplies of the image forming devices 10 connected to the network 1 are permitted to be turned off, and group information 322 that groups the image forming devices 10 connected to the network 1. As shown in FIG. 3A, a power-off-permission start hour and a power-off-permission end hour are set in the off-hour information 321. The period between the power-off-permission start hour and a power-off-permission end hour becomes the power-off-permission time zone during which the power supplies of the image forming devices 10 connected to the network 1 are permitted to be turned off. As shown in FIG. 3B, groups and device IDs of the image forming devices 10 belonging to the groups are set in the group information 322. In the example shown in FIG. 3B, it can be noted that group “001” is formed of three devices, namely “device A” having a device code “00A”, “device B” having a device code “00B” and “device C” having a device code “00C”.

The server control unit 33 is connected to the server communication unit 31 and the device information storage unit 32. The server control unit 33 controls the operation of the server 30. The server control unit 33 is an information processing unit, such as a microcomputer or the like, which includes a ROM, a RAM and the like. A control program for controlling the operation of the server 30 is stored in the ROM. By reading out the control program stored in the ROM and deploying the control program in the RAM, the server control unit 33 controls the server 30.

The server control unit 33 transmits an off-operation confirmation request, every predetermined time, to the image forming devices 10 connected to the network 1. Depending on an off-operation response received from each of the image forming devices 10, the server control unit 33 grasps whether the off-operation register 201 is set or not. If the off-operation registers 201 of the entire image forming devices 10 belong to a group are set and if the present time falls within the power-off-permission time zone, the server control unit 33 transmits a power-off request to the entire image forming devices 10 belong to the group.

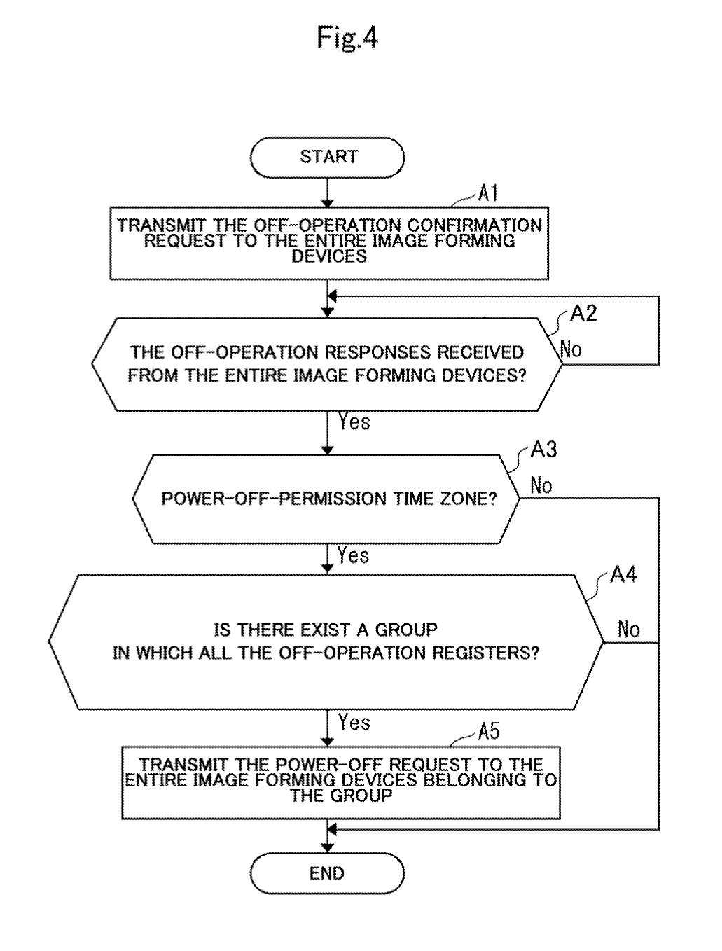

Next, a power supply management operation performed by the server 30 with respect to the image forming devices 10 connected to the network 1 will be described in detail with reference to FIG. 4.

Referring to FIG. 4, the server control unit 33 of the server 30 transmits an off-operation confirmation request, every predetermined time, to the entire image forming devices connected to the network 1 and kept in a power-on state (step A1). In the network 1, the server 30 serves as a host and the image forming devices 10 serve as terminals. Thus, the server 30 transmits the off-operation confirmation request as one example of polling performed with respect to the image forming devices 10 connected to the network 1.

Then, the server control unit 33 monitors reception of off-operation responses sent from the entire image forming devices 10 kept in a power-on state (step A2). Upon receiving the off-operation responses from the entire image forming devices 10 kept in a power-on state, the server control unit 33 determines whether the present time falls within the power-off-permission time zone set by the off-hour information 321 (step A3). If it is determined in step A3 that the present time does not fall within the power-off-permission time zone, the server control unit 33 terminates the power supply management operation.

If it is determined in step A3 that the present time falls within the power-off-permission time zone, the server control unit 33 determines, based on the received off-operation responses and the group information 322, whether there exists a group in which all the off-operation registers 201 of the image forming devices 10 belonging to the group are set (step A4). If it is determined in step A4 that there does not exist a group in which all the off-operation registers 201 are set, the server control unit 33 terminates the power supply management operation.

If it is determined in step A4 that there exists a group in which all the off-operation registers 201 are set, the server control unit 33 transmits a power-off request instructing power-off to the entire image forming devices 10 belonging to the group in which all the off-operation registers 201 of the image forming devices 10 are set (step A5). Thereafter, the server control unit 33 terminates the power supply management operation. Consequently, the control units 20 of the image forming devices 10 which have received the power-off request from the server 30 instruct the power control units 19 to turn off the power supplies, whereby the power supplies of the image forming devices 10 are turned off.

In the present embodiment, the power supply management system is configured such that the off-operation register 201 is set if an off-operation is received by the power switch 18. However, in order to cope with a situation where a user forgets to perform the off-operation, if an operation instructing each of the image forming devices 10 to operate is not received by the operation unit 11 for a predetermined time period or more, the off-operation may be regarded as having been received and the off-operation register 201 may be set. Moreover, if each of the image forming devices 10 does not perform an operation (a reading operation performed by the manuscript reading unit 13, a printing operation performed by the printing unit 16, or the like) for a predetermined time period or more, the off-operation may be regarded as having been received and the off-operation register 201 may be set. Thus, even when a user forgets to perform the off-operation, if the power-off-permission start hour elapses, the power supplies of the image forming devices 10 connected to the network 1 can be turned off by the server 30.

In the present embodiment, the power supply management system is configured such that the power supply management operation is performed by the server 30. However, one of the image forming devices 10 connected to the network 1 may be allowed to serve as a master and may be provided with the function of the server 30.

According to the present embodiment described above, there is provided a power supply management system including a plurality of image forming devices 10 connected to a network 1 and a server 30 serving as a power supply management device configured to manage power supplies of the image forming devices 10. Each of the image forming devices 10 includes a power switch 18 configured to receive an off-operation of each of the power supplies performed by a user, an off-operation register 201 serving as an off-operation holding unit for holding a situation of reception of the off-operation received by the power switch 18, and a power control unit 19 configured to turn off the power supplies upon receiving a power-off request from the server 30 via the network 1. The server 30 includes a device information storage unit 32 for storing group information that groups the image forming devices 10, and a server control unit 33 that serves as an off-operation situation grasping unit for grasping, via the network 1, the situation of reception of the off-operation held in the off-operation register 201 of each of the image forming devices 10 and serves as a power-off request transmitting unit for, based on the grasped situation of reception of the off-operation and the group information, transmitting the power-off request via the network 1 to the entire image forming devices 10 belonging to a group in which the entire image forming devices 10 have received the off-operation. With the configuration, even if the power supplies of the image forming devices 10 not in use are sequentially subjected to an off-operation, the power supplies are turned off at a stage when all the linked image forming devices 10 are no longer in use. This makes it possible to collectively manage the power supplies of the linked image forming devices 10.

According to the present embodiment, the device information storage unit 32 stores off-hour information that sets a power-off-permission time zone during which the power supplies of the image forming devices are permitted to be turned off. The server control unit 33 transmits the power-off request under a condition that the present time falls within the power-off-permission time zone. With this configuration, it is possible to manage the time zone during which the power supplies are permitted to be turned off.

According to the present embodiment, if an operation instructing each of the image forming devices 10 to operate is not received for a predetermined time period or more, the off-operation register 201 is set by regarding the off-operation as having been received. Moreover, if each of the image forming devices 10 does not perform an operation for a predetermined time period or more, the off-operation register 201 is set by regarding the off-operation as having been received. Thus, even when a user forgets to perform the off-operation, if the power-off-permission start hour elapses, the power supplies of the image forming devices 10 connected to the network 1 can be turned off by the server 30.

The technology of the present disclosure is not limited to the respective embodiments described above. It is apparent that the respective embodiments may be modified without departing from the scope of the technical concept of the technology of the present disclosure.

What is claimed is:

1. A power supply management system, comprising:
a plurality of image forming devices connected to a network; and
a power supply management device configured to manage power supplies of the image forming devices,
wherein each of the image forming devices includes a power switch configured to receive an off-operation of each of the power supplies performed by a user, an off-operation holding unit for holding a situation of reception of the off-operation received by the power switch, and a power control unit configured to turn off the power supplies upon receiving a power-off request from the power supply management device via the network, and
wherein the power supply management device includes a device information storage unit for storing group information that groups the image forming devices, an off-operation situation grasping unit for grasping, via the network, the situation of reception of the off-operation held in the off-operation holding unit of each of the image forming devices, and a power-off request transmitting unit for, based on the situation of reception of the off-operation grasped by the off-operation situation grasping unit and the group information, transmitting the power-off request via the network to the entire image forming devices belonging to a group in which the entire image forming devices have received the off-operation.

2. The system of claim 1, wherein the device information storage unit stores off-hour information that sets a power-off-permission time zone during which the power supplies are permitted to be turned off, and the power-off request transmitting unit transmits the power-off request under a condition that the present time falls within the power-off-permission time zone.

3. The system of claim 1, wherein, if an operation instructing each of the image forming devices to operate is not received for a predetermined time period or more, the off-operation holding unit holds the situation of reception of the off-operation by regarding the off-operation as having been received.

4. The system of claim 1, wherein, if each of the image forming devices does not perform an operation for a predetermined time period or more, the off-operation holding unit holds the situation of reception of the off-operation by regarding the off-operation as having been received.

5. An image forming device for use in a power supply management system which includes a plurality of image forming devices connected to a network and a power supply management device configured to manage power supplies of the image forming devices, the image forming device comprising:
a power switch configured to receive an off-operation of each of the power supplies performed by a user;
an off-operation holding unit for holding a situation of reception of the off-operation received by the power switch; and
a power control unit configured to turn off the power supplies upon receiving a power-off request from the power supply management device via the network,
wherein the power supply management device includes a device information storage unit for storing group information that groups the image forming devices, an off-operation situation grasping unit for grasping, via the network, the situation of reception of the off-operation held in the off-operation holding unit of each of the image forming devices, and a power-off request transmitting unit for, based on the situation of reception of the off-operation grasped by the off-operation situation grasping unit and the group information, transmitting the power-off request via the network to the entire image forming devices belonging to a group in which the entire image forming devices have received the off-operation.
